(19) United States
(12) Patent Application Publication
(10) Pub. No.: US 2016/0090123 A1
(43) Pub. Date: Mar. 31, 2016

(54) STEERING WHEEL POSITION DISPLAY

(71) Applicant: Panasonic Automotive Systems Company of America, Division of Panasonic Corporation of North America, Peachtree City, GA (US)

(72) Inventor: NAJAMUZ ZAMAN, WESTLAND, MI (US)

(73) Assignee: Panasonic Automotive Systems Company of America, Division of Panasonic Corporation of North America

(21) Appl. No.: 14/856,745

(22) Filed: Sep. 17, 2015

Related U.S. Application Data
(60) Provisional application No. 62/056,203, filed on Sep. 26, 2014.

(51) Int. Cl. B62D 15/02

(52) U.S. Cl. CPC B62D 15/0295; B62D 15/021

(57) ABSTRACT

A method of informing a driver of a motor vehicle of the position of a steering wheel of the vehicle includes sensing a rotational position of the steering wheel, and determining where on a spectrum of possible steering wheel positions the sensed rotational position lies. A bar indicator is provided on an in-vehicle display screen. The bar indicator includes a plurality of horizontally aligned bars. At least one bar on the bar indicator corresponding to the sensed rotational position on the spectrum of possible steering wheel positions is colored or highlighted.

### CROSS-REFERENCE TO RELATED APPLICATIONS

This application claims the benefit of U.S. Provisional Application No. 62/056,203, filed on Sep. 26, 2014, which the disclosure of which is hereby incorporated by reference in its entirety for all purposes.

### FIELD OF THE INVENTION

The disclosure relates to a method and apparatus for informing a driver of a motor vehicle of a rotational position of the steering wheel of the vehicle,

### SUMMARY

The invention provides two ways to implement a steering wheel position indicator. In a first method, a dashboard or other display of the vehicle is used to display an indication of the steering wheel position on the screen image along the calibrated rear camera view. In a second method, an LED bar display is installed on the upper rear windshield. Such a display of the steering wheel position may be particularly useful when a driver is backing since the driver can see the steering position when reversing.

The invention comprises in one form thereof, a method of informing a driver of a motor vehicle of the position of a steering wheel of the vehicle. A rotational position of the steering wheel is sensed, and it is determined where on a spectrum of possible steering wheel positions the sensed rotational position lies. A bar indicator is provided on an in-vehicle display screen. The bar indicator includes a plurality of horizontally aligned bars. At least one bar on the bar indicator corresponding to the sensed rotational position on the spectrum of possible steering wheel positions is colored or highlighted.

The invention comprises in another form thereof, a method of informing a driver of a motor vehicle of the position of a steering wheel of the vehicle. A rotational position of the steering wheel is sensed. An audio system of the vehicle is used to provide an audible, spoken indication of the sensed rotational position.

The invention comprises in yet another form thereof, a method of informing a driver of a motor vehicle of the position of a steering wheel of the vehicle, including sensing a rotational position of the steering wheel. A linear array of illumination elements is provided within a passenger compartment of the vehicle. At least one of the illumination elements or a range of the illumination elements is colored, highlighted or illuminated dependent upon the sensed rotational position of the steering wheel.

The invention in yet another form thereof may utilize illumination elements placed in an instrument duster to caution driver about the wheel position as an added safety feature.

### BRIEF DESCRIPTION OF THE DRAWINGS

A better understanding of the present invention will be had upon reference to the following description in conjunction with the accompanying drawings.

FIG. 1 is an example screen shot of an in-vehicle display including a steering wheel position indicator bar of the present invention with the vehicle in reverse and the steering wheel being in a centered straight position.

FIG. 2 is another example screen shot of an in-vehicle display including a steering wheel position indicator bar of the present invention with the vehicle in reverse and the steering wheel being turned completely counterclockwise in a leftmost position.

FIG. 3 is yet another example screen shot of an in-vehicle display including a steering wheel position indicator bar of the present invention with the vehicle in reverse and the steering wheel being turned completely clockwise in a rightmost position.

FIG. 4 is a block, diagram illustrating the reading of the steering angle.

### DETAILED DESCRIPTION OF THE PREFERRED EMBODIMENTS

### Glossary

Rotational position—a quantification of how far a steering wheel has been rotated in a clockwise or counterclockwise direction from a neutral position in which the vehicle is steered straight ahead.
Pitch—the quality of a sound determined by the rate of vibrations producing it; the degree of highness or lowness of a tone.
Array—an ordered arrangement.

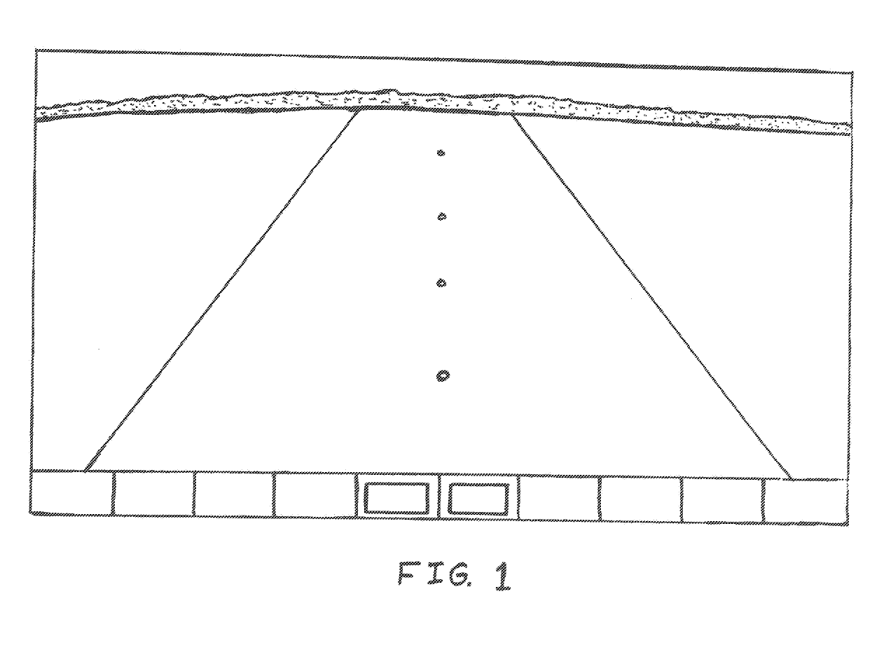

FIG. 1 illustrates one embodiment of a steering wheel position bar indicator of the present invention which is included in an in-vehicle display screen. The steering wheel is in a center position in which the vehicle is steered in a straight ahead direction. Accordingly, the center two bars of a series of horizontally aligned bars that for the bar indicator are highlighted or colored in (e.g., filled with color). Each bar on the bar indicator may represent a respective rotational position of the steering wheel/steering column along a spectrum of possible rotational positions. Alternatively, the steering wheel position indicator bar may be implemented by utilizing alpha-blending in order to save space on the screen. The term “alpha-blending” may refer to the presentation of two images on a screen by combining and/or blending the images on the screen with some level of transparency in one or both of the images.

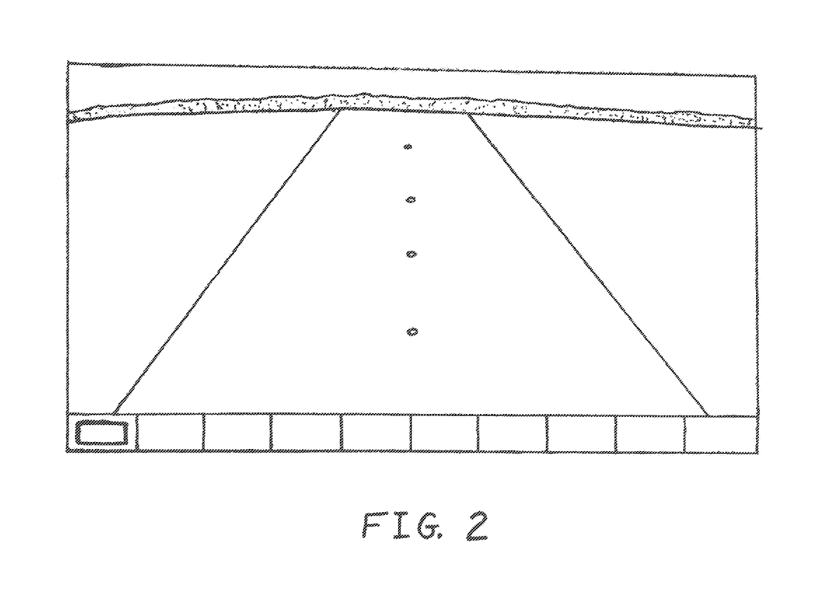

FIG. 2 illustrates an example of the steering wheel position bar indicator of FIG. 1 wherein the steering wheel is in a fully counterclockwise or leftmost position in which the vehicle is steered in a most leftward direction. Accordingly, the leftmost bar of the bar indicator is highlighted or colored in (e.g., filled with color).

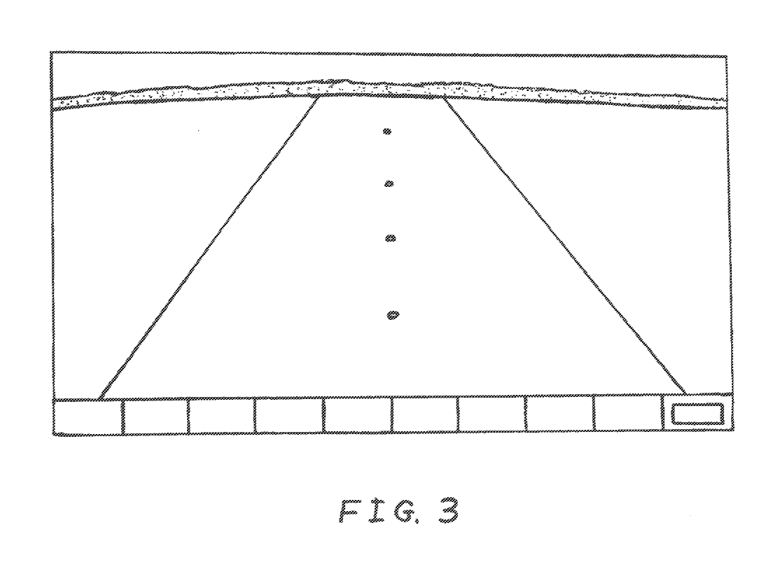

FIG. 3 illustrates an example of the steering wheel position bar indicator of FIG. 1 wherein the steering wheel is in a fully clockwise or rightmost position in which the vehicle is steered in a most rightward direction. Accordingly, the rightmost bar of the bar indicator is highlighted or colored in (e.g., filled with color).

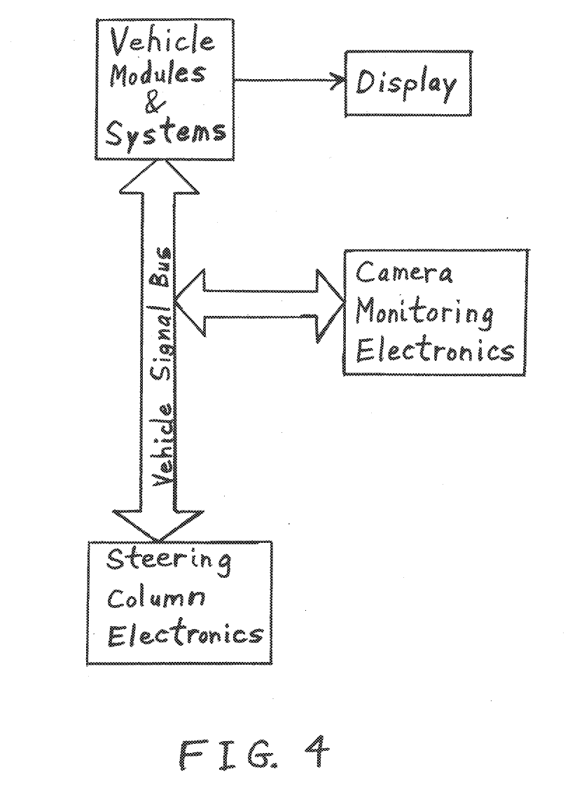

The steering wheel angle or position may be determined by steering column electronics, such as sensors which may send that information indicating steering wheel angle or position to other vehicle modules or systems via the vehicle signal bus. Camera monitoring electronics can take advantage of the steering wheel angle information by reading the appropriate message on the vehicle bus, as illustrated in FIG. 4. The steering electronics may send the relative angle if the auto park feature is not installed on the vehicle. However, if the auto park feature is installed, then another method may be used to generate and send the absolute steering angle.

After more processing is performed on the angle by the software embedded in the rear camera electronics and processor (which may be included in the “Vehicle Modules & Systems” in FIG. 4), an indication of the steering wheel position on the steering wheel position indicator bar may be realized as shown in FIGS. 1-3.

The invention may be alternatively implemented by utilizing the audio system in the vehicle. The audio system may be used to make audible audio announcements about the steering wheel position. Examples of such announcements may be “Steering is centered”, “Vehicle will move straight”, “Vehicle veering left”, or “Vehicle veering right”. The announcement may also indicate whether the turning angle is sharp (i.e., a high degree of rotation) or soft (i.e., a low degree of rotation). If the vehicle is moving forward while veering or turning, the audible announcements may not mention the forward directions because the forward direction of the vehicle is assumed. However, if the vehicle is moving backward while veering or turning, the audible announcements may mention the backward direction. The words included in the audible announcement to indicate the veering or turning direction while moving backward may be programmable by the user so that the announcement will make sense to him and will be understandable by him. For example, the user may speak the format of the announcement into an in-vehicle microphone, such as “Vehicle going in reverse and veering right as you look backward”, or “Vehicle going in reverse and veering to the driver side of the vehicle”. The choice between these two formats may be audibly presented to the user upon system set up, and the user may choose one of these two formats. Each user of the vehicle may choose his own verbal formats, and the user's preferred formats may be automatically implemented upon the system identifying the driver, similarly to vehicular memory seat systems.

In another embodiment that provides an audible indication, of steering direction, a series of audible beeps may be emitted while the steering wheel is turned, with the pitch of the beeps varying with the degree of steering wheel rotation. For example, the lowest pitch beeps may be provided when the vehicle is going straight, and the highest pitch beeps may be provided when the steering wheel is turned fully clockwise or counterclockwise. A respective audible beep pitch may correspond to each range of steering wheel rotation. In one embodiment, the beep pitch corresponds to a range of steering wheel rotation in both the clockwise and counterclockwise directions.

In another embodiment, which does not include the in-vehicle display, such as a display rear seat or dashboard display, the apparatus may directly drive the bar indicator. The bar indicator may include a linear array of light emitting diodes (LEDs) mounted near the upper edge of the vehicle's rear windshield. The LEDs may be lit similarly to manner in which the bars are lit in FIGS. 1-3. The driver, when looking back, and while driving in a reverse direction, may view the LED bar indicator located near the upper edge of the rear windshield within the passenger compartment.

The invention is described above as being implemented in conjunction with a display screen or discrete LEDs. In yet another embodiment, the bar indicator is provided in a head up display (HUD) provided in association with the windshield and/or the rear window.

The invention is described above as including a linear array of bars. However, it is also possible within the scope of the invention to include an arcuate array of bars.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A method of informing a driver of a motor vehicle of the position of a steering wheel of the vehicle, the method comprising:
sensing a rotational position of the steering wheel;
determining where on a spectrum of possible steering wheel positions the sensed rotational position lies;
presenting a bar indicator on an in-vehicle display screen, the bar indicator including a plurality of horizontally aligned bars; and
coloring or highlighting at least one bar on the bar indicator corresponding to the sensed rotational position on the spectrum of possible steering wheel positions.

2. The method of claim 1, wherein the bars are aligned along a bottom edge of the display screen.

3. The method of claim 1, wherein when the rotational position of the steering wheel causes the vehicle to drive straight ahead, a middle one of the bars is colored or highlighted.

4. The method of claim 1, wherein at least one bar on the bar indicator corresponding to the sensed rotational position on the spectrum of possible steering wheel positions is colored a different color than all other said bars on the bar indicator.

5. The method of claim 1, wherein when the rotational position of the steering wheel is a fully clockwise position, a rightmost bar on the bar indicator is colored or highlighted, and when the rotational position of the steering wheel is a fully counterclockwise position, a leftmost bar on the bar indicator is colored or highlighted.

6. The method of claim 1, further comprising providing an audible indication of the sensed rotational position.

7. The method of claim 6, wherein the an audible indication of the sensed rotational position comprises beeps with a pitch varying with an angle of steering wheel rotation relative to a center position in which the vehicle travels straight ahead.

8. A method of informing a driver of a motor vehicle of the position of a steering wheel of the vehicle, the method comprising:
sensing a rotational position of the steering wheel; and
using an audio system of the vehicle to provide an audible, spoken indication of the sensed rotational position.

9. The method of claim 8, wherein a format of the spoken indication is selectable by a user of the motor vehicle.

10. The method of claim 8, wherein the spoken indication indicates whether the vehicle is in a forward gear or a reverse gear.

11. The method of claim 8, wherein the spoken indication indicates a degree of rotation of the steering wheel.

12. The method of claim 8, further comprising providing audible beeps wherein a pitch of the beeps varies with a degree of rotation of the steering wheel.

13. The method of claim 8, further comprising providing a visible indication of the sensed rotational position.

14. The method of claim 13, wherein the providing of the visible indication comprises:
presenting a plurality of visible elements on an in-vehicle display screen; and
coloring or highlighting at least one said visible element corresponding to the sensed rotational position.

15. A method of informing a driver of a motor vehicle of the position of a steering wheel of the vehicle, the method comprising:
sensing a rotational position of the steering wheel;
providing an array of illumination elements within a passenger compartment of the vehicle; and
coloring, highlighting or illuminating at least one of the illumination elements or a range of the illumination elements dependent upon the sensing step.

16. The method of claim 15, wherein the array is a linear array.

17. The method of claim 15, comprising the further step of providing audible beeps dependent upon the sensing step, a pitch of the beeps varying with the sensed rotational position of the steering wheel, each said illumination element corresponding to a predetermined level of the pitch.

18. The method of claim 15, wherein the illumination elements are horizontally aligned along a bottom edge of a rectangular display screen.

19. The method of claim 15, wherein when the rotational position of the steering wheel is a fully clockwise position, a rightmost said illumination element is colored, highlighted or illuminated, and when the rotational position of the steering wheel is a fully counterclockwise position, a leftmost said illumination element is colored, highlighted or illuminated.

20. The method of claim 15, further comprising using a computer generated voice to provide a spoken indication of the sensed rotational position.
